(19) United States
(12) Patent Application Publication
(10) Pub. No.: US 2014/0045078 A1
(43) Pub. Date: Feb. 13, 2014

(54) LITHIUM AIR BATTERY CELL

(71) Applicants: Johannes Eicher, Sehnde (DE); Jens Olschimke, Hannover (DE); Martin Bomkamp, Hannover (DE); Placido Garcia-Juan, Bad Honnef (DE)

(72) Inventors: Johannes Eicher, Sehnde (DE); Jens Olschimke, Hannover (DE); Martin Bomkamp, Hannover (DE); Placido Garcia-Juan, Bad Honnef (DE)

(73) Assignee: SOLVAY SA, Bruxelles (BE)

(21) Appl. No.: 14/113,436

(22) PCT Filed: Apr. 19, 2012
(86) PCT No.: PCT/EP2012/057169

§ 371 Date: Oct. 23, 2013

(30) Foreign Application Priority Data
Apr. 26, 2011 (EP) 11163685.8

(51) Int. Cl. H01M 8/22

(52) U.S. Cl. CPC H01M 8/22
USPC 429/403

(57) ABSTRACT

A lithium-air battery cell with an electrolyte composition comprising LiPO₂F₂ is described. The electrolyte composition comprises an electrolyte solvent, for example, one or more non-fluorinated solvents, e.g. ethylene carbonate, a dialkyl carbonate or propylene carbonate, and/or one or more fluorinated organic solvents, e.g. fluoroethylene carbonate, cis-difluoroethylene carbonate, trans-difluoroethylene carbonate, 4,4-di-fluoroethylene carbonate, trifluoroethylene carbonate, tetrafluoroethylene carbonate, 4-fluoro-4-methyl-1,3-dioxolane-2-one, 4-fluoro-4-ethyl-1,3-dioxolane-2-one, 2,2,2-tri-fluoroethyl-methyl carbonate, 2,2,2-trifluoroethyl-fluoromethyl carbonate are preferred. The solvent may further comprise other additives. Also described is a vehicle battery, especially a car battery constituted of a multitude of lithium-air battery cells of the invention. The battery can be used to provide electrical energy to consumers for electric current including an electric motor driving the vehicle.

The present invention concerns a lithium-air battery cell and a lithium-air battery which contain LiPO₂F₂ as additive.

Rechargeable lithium-air batteries are suitable as storage media for electrical energy and useful for household items, e.g. cell phones or laptops, and they are especially suitable as car batteries. Lithium-air batteries, shortly, “Li—O batteries”, comprise one or more lithium-air battery cells containing lithium anodes electrochemically coupled to atmospheric oxygen. The oxygen is usually taken from the atmosphere and thus is an unlimited cathode reactant. The lithium-air battery has a much higher energy density than the currently existing lithium ion batteries, and is rechargeable. The underlying principle is that the battery cell comprises a metal anode in an anode compartment and a cathode (for example, porous carbon), with a gel-polymer electrolyte membrane or a non-aqueous solvent which serve as ion-transporting medium. Often, a membrane—for example, a Lisicon membrane or a Nasicon membrane—which is permeable for the metal cation, but impermeable for other compounds like water or solvent, serves to effectively separate anode and cathode compartments. If discharged, the respective metal is oxidized to the respective metal cation, the formed cation is transported via membrane and solvent to the cathode compartment and forms there the metal oxide. If rechargeable, the metal ions are migrating back to the anode compartment and are reduced to the respective metal, while the oxide is oxidized to oxygen. To prevent the intrusion of water the cathode compartment may be separated from the surrounding air by a water-repelling membrane, e.g. a Teflon® membrane.

The object of the present invention is to provide a lithium-air battery cell with improved additives and solvents and a battery, especially a car battery, constituted from a multitude of such lithium-air cells. These and other objects are achieved by the lithium-air battery cell and the battery for vehicles, especially for cars, as stated in the claims.

According to the present invention, a lithium-air battery cell is provided comprising an electrolyte composition which comprises LiPO₂F₂.

In a lithium-air battery, during discharge, on the anode, Li is oxidized forming Li⁺. On the cathode, oxygen is reduced to form the O₂²⁻ ion and the O²⁻ ion. Upon charging of the lithium-air battery cell, the reverse reactions happen. Li₂O or Li₂O₂, respectively, which have formed during discharge, are split at the cathode to finally produce elemental oxygen.

### BRIEF DESCRIPTION OF THE DRAWING

FIG. 1 shows an example of a Li-air battery cell.

### DETAILED DESCRIPTION OF THE INVENTION

A lithium-air battery cell is provided comprising an electrolyte solvent which comprises LiPO₂F₂ as electrolyte salt or as additive. The term “battery cell” denotes a cell for a battery or a battery comprising a single battery cell. The terms “battery” denotes an item comprising a single cell or a multitude of cells. Thus, a battery comprising a single cell may be denoted “battery” or “battery cell” in the present description. In a battery with a multitude of cells, these cells are usually assembled in line to achieve a higher voltage than a single cell has.

### Description of the Drawing

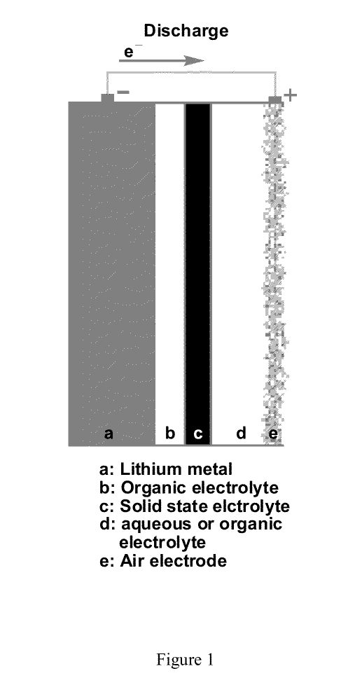

FIG. 1 presents a battery cell for car battery according to the present invention.

The cell is covered by a battery housing which is omitted from FIG. 1. The anode a is formed by lithium metal. In the anode compartment b, an organic electrolyte solvent is contained. Suitable electrolyte solvents are described in more detail below. The membrane c (a solid state electrolyte) separates the anode compartment b which is in contact with the lithium metal of anode a, and the cathode compartment d which is in contact with the air electrode e. It is made from material which is permeable for Li ions, but not for other components present in the anode compartment b and anode compartment d. For example, Lisicon membranes are suitable here. The cathode compartment may comprise, in the embodiment of FIG. 1, an aqueous electrolyte composition or an organic electrolyte composition. If present, the organic electrolyte composition of the cathode compartment d is preferably essentially identical to the organic electrolyte composition in the anode compartment b.

To provide a battery with higher voltage than the voltage provided by a single Li-air battery cell, several battery cells can be assembled to achieve the desired combined voltage of, for example, twelve or more Li-air cells.

The lithium-air battery cell of the invention may comprise an electrolyte salt which is selected among salts known to the expert to be suitable for this purpose. Such salts have the general formula MₐA_{b}. M is a metal cation, and A is an anion. M is preferably selected from Li⁺, and NR₄⁺. Preferred anions are PF₆⁻, AsF₆⁻, BF₄⁻, ClO₄⁻.

Preferably, M is Li⁺. Especially preferably, M is Li⁺ and the solution comprises an electrolyte salt selected from the group consisting of LiBF₄, LiClO₄, LiAsF₆, LiPF₆, LiN(CF₃SO₂)₂ and LiN(i-C₃F₇SO₂)₂. Lithium bis(oxalato)borate can be applied as an additional additive. The concentration of the electrolyte salt is preferably 1±0.1 molar.

If LiPO₂F₂ is the only electrolyte salt, its concentration in the electrolyte solution is, as mentioned, preferably 1±0.1 molar. If LiPO₂F₂ is applied as an additive together with another electrolyte salt, the electrolyte solution is a composition comprising the electrolyte solvent, the electrolyte salt and additives, notably the LiPO₂F₂, the concentration of LiPO₂F₂ in the electrolyte solution (i.e. the electrolyte composition) preferably is equal to or greater than 0.1% by weight, more preferably equal to or greater than 0.5% by weight; preferably, its concentration is equal to or lower than 10% by weight, more preferably, equal to or lower than 5% by weight when the total electrolyte composition including electrolyte salt, solvent and additives is set as 100% by weight. Preferably, the content of LiPO₂F₂ is 1 to 10% by weight, more preferably 1 to 5% by weight, relative to the electrolyte composition set as 100% by weight.

The solvent used in the electrolyte may comprise any non-fluorinated and/or fluorinated solvent or solvent mixture known to be useful for rechargeable battery cells, especially, known to be useful for rechargeable battery cells based in Li salts. The term “fluorinated” denotes partial or total substitution of hydrogen atoms in the solvent. The fluorosubstituted compounds may be contained in lower amounts, e.g. in an amount of 0.1% by weight respective to the total content of solvent, up to about 10% by weight respective to the total amount of solvent. They might then be considered rather as solvent additive than solvent. The content of fluorosubstituted compound may even be higher than 10% by weight, and in this case, they may be considered rather as solvent. Suitable solvents for the electrolyte composition may be selected from the group consisting of with linear or cyclic ethers, linear and cyclic esters, linear and cyclic ketones, saturated and unsaturated linear and cyclic alkanes, aromatic hydrocarbons and especially linear and cyclic organic carbonates. Alkyl carbonates and alkylene carbonates are the preferred solvent. The term “alkyl” preferably denotes a C1 to C3 group. The term “alkylene” preferably denotes an alkylene group with a C2, C3 or C4 chain which is arranged between the oxygen atoms of an O—C(O)—O group. The alkylene group may be substituted by one or more C1 to C3 alkyl groups, e.g. by one or two methyl groups and/or one or two ethyl groups. Often, ethylene carbonate (EC) is comprised in the solvent. Propylene carbonate and butylene carbonate are other solvents which may be a suitable constituent of the electrolyte solution. The solvent may instead or additionally contain low viscosity agents, e.g. ethers like 1,2-dimethoxyethane, tetrahydrofuran, 2-methyltetrahydrofuran, 1,3-dioxolane, 4-methyldioxolane, dimethylcarbonate, ethylmethyl carbonate, diethyl carbonate and any mixtures thereof. Nitriles with a C1 to C20 alkyl group, e.g. acetonitrile, dinitriles with a C1 to C20 alkylene group, t-amyl benzene, and thiosubstituted compounds, for example, ethylene-1,3-dioxolane-2-thione (ethylene thiocarbonate) are also highly suitable non-fluorinated solvents or additives.

As indicated above, the solvent or solvent mixture contained in the electrolyte solution may also comprise or consist of one or more fluorosubstituted organic compounds. For example, at least one fluorosubstituted organic compound which contains at least one heteroatom selected from the group consisting of oxygen, nitrogen, phosphorous, sulfur and silicon may be comprised or constitute the only solvent. The electrolyte solvent or solvent mixture (be it fluorosubstituted or not) is selected such that it is liquid at the temperature at which the battery is intended to be used. If the melting point of the respective fluorosubstituted organic compound (just as any respective non-fluorinated compound) is low enough it can be used neat. The melting point of monofluoroethylene carbonate (“F1EC”), for example, is at about 22° C. Thus, it is preferred to apply this compound with a co-solvent with a lower melting point, e.g. with dimethyl carbonate or diethyl carbonate which have a melting point of about 2 to 4° C., with ethyl methyl carbonate having a melting point of −14.5° C., or with propylene carbonate with a melting point in the range of −50° C. Accordingly, in this case, the solvent is a solvent mixture. Preferably, the electrolyte solvent or solvent mixture is liquid at a temperature equal to or above −20° C.

In the following, highly suitable fluorosubstituted organic compounds are mentioned which are suitable as solvents or additional solvents. Preferred fluorinated organic compounds are selected from the group consisting of mono fluorinated, difluorinated, trifluorinated, polyfluorinated and perfluorinated organic compounds. Here, the term “polyfluorinated” denotes compounds which are substituted by four or more fluorine atoms, but contain at least one hydrogen atom, or at least one chlorine atom, or at least one hydrogen atom and at least one chlorine atom. Preferably, the monofluorinated, difluorinated, trifluorinated, polyfluorinated and perfluorinated organic compounds are not substituted by chlorine atoms. “Perfluorinated” are those compounds in which all hydrogen atoms are substituted by fluorine atoms.

Suitable compounds are those described in WO2007/042471. That document discloses compounds useful to be applied the present invention selected from the group of aromatic compounds consisting of 1-acetoxy-2-fluorobenzene, 1-acetoxy-3-fluorobenzene, 1-acetoxy-4-fluorobenzene, 2-acetoxy-5-fluorobenzyl acetate, 4-acetyl-2,2-difluoro-1,3-benzodioxole, 6-acetyl-2,2,3,3-tetrafluorobenzo-1,4-dioxin, 1-acetyl-3-trifluoromethyl-5-phenylpyrazole, 1-acetyl-5-trifluoromethyl-3-phenylpyrazole, benzotrifluoride, benzoyltrifluoroacetone, 1-benzoyl-3-trifluoromethyl-5-methylpyrazole, 1-benzoyl-5-trifluoromethyl-3-methylpyrazole, 1-benzoyloxy-4-(2,2,2-trifluoroethoxy)benzene, 1-benzoyl-4-trifluoromethylbenzene, 1,4-bis(t-butoxy)tetrafluorobenzene, 2,2-bis(4-methylphenyl)hexafluoropropane, bis(pentafluorophenyl)carbonate, 1,4-bis(1,1,2,2-tetrafluoroethoxy)benzene, 2,4-bis(trifluoromethyl)benzaldehyde, 2,6-bis(trifluoromethyl)benzonitrile, difluoroacetophenone, 2,2-difluorobenzodioxole, 2,2-difluoro-1,3-benzodioxole-4-carbaldehyde, 1-[4-(difluoromethoxy)phenyl]ethanone, 3-(3,5-difluorophenyl)-1-propene, fluorobenzophenone, difluorobenzophenone, 1-(2′-fluoro[1,1′-biphenyl]-4-yl)propan-1-one, 6-fluoro-3,4-dihydro-2H-1-benzothiin-4-one, 4-fluorodiphenyl ether, 5-fluoro-1-indanone, 1-(3-fluoro-4-methoxyphenyl)ethanone, fluorophenylacetonitrile,

the group of compounds having an Si—C bond consisting of bis(pentafluorophenyl)dimethylsilane, 1,2-bis[difluoro(methyl)silyl]ethane, N,O-bis(trimethylsilyl)trifluoroacetamide, N-(t-butyldimethylsilyl)-N-methyltrifluoroacetamide, t-butyldimethylsilyl trifluoromethanesulphonate, 2-dimethylamino-1,3-dimethylimidazolium trimethyldifluorosiliconate, diphenyldifluorosilane,

the group of compounds having a C═O bond consisting of bis(1,1,1,3,3,3-hexafluoroprop-2-yl)2-methylenesuccinate, bis(1,1,1,3,3,3-hexafluoroprop-2-yl)maleate, bis(2,2,2-trifluoroethyl)maleate, bis(perfluorooctyl)fumarate, bis(perfluoroisopropyl)ketone, 2,6-bis(2,2,2-trifluoroacetyl)cyclohexanone, butyl 2,2-difluoroacetate, cyclopropyl 4-fluorophenyl ketone, diethyl perfluoroadipate, N,N-diethyl-2,3,3,3-tetrafluoropropionamide,

the group of compounds having a C═C bond consisting of allyl 1H,1H-heptafluorobutyl ether, trans-1,2-bis(perfluorohexyl)ethylene, (E)-5,6-difluoroocta-3,7-diene-2-one,

the group of amines consisting of N,N-diethyl-1,1,2,3,3,3-hexafluoropropylamine

These compounds are applicable as additive or additives for electrolyte solvents in lithium-air batteries. The solvent may also additionally contain benzene, fluorobenzene, toluene, trifluorotoluene, xylene or cyclohexane.

The term “difluoroacetophenone” encompasses the isomers with the fluorine substitution in the 2,3-, 2,4-, 2,5-, 2,6-, 3,4- and 3,5-position on the aromatic ring.

The term “fluorobenzophenone” encompasses in particular the isomers 2-fluorobenzophenone and 4-fluorobenzophenone.

The term “difluorobenzophenone” encompasses the isomers with the fluorine substitution in the 2,3′-, 2,3-, 2,4′-, 2,4-, 2,5-, 2,6-, 3,3′-, 3,4′-, 3,4-, 3,5- and 4,4′-position.

The term “fluorophenylacetonitrile” encompasses the isomers with the fluorine substitution in the 2-, 3- and 4-position.

The compounds can be synthesized in a known manner and are also commercially available, for example from ABCR GmbH & Co. KG, Karlsruhe, Germany.

Preferred fluorinated organic compounds are selected from the group of fluorosubstituted carboxylic acid esters, fluorosubstituted carboxylic acid amides, fluorosubstituted fluorinated ethers, fluorosubstituted carbamates, fluorosubstituted cyclic carbonates, fluorosubstituted acyclic carbonates, fluorosubstituted phosphites, fluorosubstituted phosphoranes, fluorosubstituted phosphoric acid esters, fluorosubstituted phosphonic acid esters and saturated or unsaturated fluorosubstituted heterocycles.

Suitable fluorinated ethers applicable as solvent or solvent additive are for example those as described in U.S. Pat. No. 5,916,708, namely partially fluorinated ethers of formula (I)

RO—[(CH₂)ₘO]ₙ—CF₂—CFH—X (I)

wherein
R is a linear alkyl group with 1 to 10 C atoms or a branched alkyl group with 3 to 10 C atoms,
X is fluorine, chlorine or a perfluoroalkyl group with 1 to 6 C atoms which groups may include ether oxygen,
m is an integer of 2 to 6 and
n is an integer of 1 to 8,
   and/or of formula (II)

X—CFH—CF₂O—[(CH₂)ₘO]ₙ—CF₂—CFH—X (II)

wherein
X, m and n have the meaning given above.

Partially fluorinated carbamates suitable as solvent additives are for example those described in U.S. Pat. No. 6,159,640, namely compounds of the formula R¹R²N—C(O)OR³ wherein R¹ and R² independently are the same or different, and are linear C1-C6-alkyl, branched C3-C6-alkyl, C3-C7-cycloalkyl, or R¹ and R² are connected directly or via one or more additional N and/or O atoms forming a ring with 3 to 7 members. Optionally, additional N atoms in the ring are saturated with C1 to C3 alkyl groups, and additionally, the carbon atoms of the ring may be substituted by C1 to C3 alkyl groups. In the groups R¹ and R², one or more hydrogen atoms may be substituted by fluorine atoms. R³ is a partially fluorinated or perfluorinated linear or branched alkyl group with 1 to 6 or, respectively, 3 to 6 carbon atoms, or a partially or perfluorinated cycloalkyl group with 3 to 7 C atoms, which may be substituted by one or more C1 to C6 alkyl groups.

Fluorinated acetamides suitable as solvent additive are for example those described U.S. Pat. No. 6,489,064, namely partially fluorinated amide corresponding to formula (I) R¹CO—NR²R³ (III) wherein R¹ is a linear C1-C6 alkyl group in which at least one hydrogen atom is replaced by fluorine, or a branched C3-C6 alkyl group in which at least one hydrogen atom is replaced by fluorine, or a C3-C7 cycloalkyl group optionally substituted one or more times by a linear C1-C6 alkyl group or branched C3-C6 alkyl group or both in which at least one hydrogen atom of the cycloalkyl group or the optional linear or branched alkyl substituent or both is replaced by fluorine, and R² and R³ independently represent an identical or different linear C1-C6 alkyl group, a branched C3-C6 alkyl group or a C3-C7 cycloalkyl group, or together with the amide nitrogen form a saturated five or six-membered nitrogen-containing ring, or are joined with one or more additional N and/or O atom(s) to form a 4 to 7-membered ring in which the additional N atoms present in the ring are optionally saturated with C1-C3 alkyl groups and the ring carbon atoms may also carry C1-C3 alkyl groups.

Partially fluorinated esters suitable as solvent or solvent additive are for example those described in U.S. Pat. No. 6,677,085 partially fluorinated compound derived from a diol corresponding to formula (IV): R¹CO—O—[CHR³(CH₂)ₘ—O_{]}—R² (IV) wherein R¹ is a (C1-C8) alkyl group or a (C3-C8) cycloalkyl group, wherein each of said groups is partially fluorinated or perfluorinated so that at least one hydrogen atom of the group is replaced by fluorine; R² is a (C1-C8) alkyl carbonyl or (C3-C8) cycloalkyl carbonyl group, wherein said alkylcarbonyl or cycloalkylcarbonyl group may optionally be partially fluorinated or perfluorinated; R³ is a hydrogen atom or a (C1-C8) alkyl or (C3-C8) cycloalkyl group; m is 0, 1, 2 or 3, and n is 1, 2 or 3.

Especially preferred are linear or branched fluorosubstituted dialkyl carbonates and fluorosubstituted alkylene carbonates.

Fluorinated dialkyl carbonates suitable as solvent or solvent additive are those of formula (V)

R¹—O—C(O)—O—R² (V)

In the compounds of formula (V), R¹ and R² can be the same or different with the proviso that at least one of R¹ and R² are substituted by at least one fluorine atom. R¹ and R² are preferably linear alkyl groups with 1 to 8 carbon atoms, preferably, 1 to 4 carbons, more preferably, with 1 to 3 carbon atoms; branched alkyl groups with 3 to 8 carbon atoms, preferably with 3 carbon atoms; or cyclic alkyl groups with 5 to 7 carbon atoms, preferably, 5 or 6 carbon atoms; with the proviso that at least one of R¹ and R² is substituted by at least one fluorine atom.

Highly preferably, R¹ and R² denote linear alkyl groups with 1 to 3 carbon atoms, with the proviso that at least one of R¹ and R² is substituted by at least one fluorine atom. Most preferably, R¹ and R² are selected from the group consisting of methyl, fluoromethyl, difluoromethyl, trifluoromethyl, ethyl, 1-fluoroethyl, 2-fluoroethyl, 1,1-difluoroethyl, 1,2-difluoroethyl, 2,2,2-trifluoroethyl and 1-fluoro-1-methylethyl. Most preferred compounds of formula (V) are methyl fluoromethyl carbonate, fluoromethyl ethyl carbonate, methyl 2,2,2-trifluoroethyl carbonate, fluoromethyl 2,2,2-trifluoroethyl carbonate and bis-2,2,2-trifluoroethyl carbonate. Such compounds can be manufactured from phosgene, COFCl or COF₂, and the respective alcohols, or as described in unpublished EP patent application No. 09155665.2. According to that process, the manufacture of fluoroalkyl (fluoro)alkyl carbonates of the general formula (Vi), FCHR—OC(O)—OR′ wherein R denotes linear or branched alkyl with 1 to 5 C atoms or H and R′ denotes linear or branched alkyl with 1 to 7 carbon atoms; linear or branched alkyl with 2 to 7 carbon atoms, substituted by at least one fluorine atom; phenyl; phenyl, substituted by 1 or more C1 to C3 alkyl groups atoms or phenyl substituted by 1 or more chlorine or fluorine atoms; or benzyl includes a step of reacting a fluoroalkyl fluoroformate of formula (VII), FCHROC(O)F, or a fluoroalkyl chloroformate of formula (VII′), FCHROC(O)Cl, with an alcohol of formula (VIII), R′OH, wherein R and R′ have the meanings given above, or includes a step of reacting a chloroalkyl fluoroformate of formula (IX), ClCHROC(O)F, or a chloroalkyl chloroformate of formula (IX′), ClCHROC(O)Cl, wherein R has the meaning given above, with an alcohol of formula (VIII), R′OH wherein R′ has the meaning given above, and a subsequent chlorine-fluorine exchange. The term “fluoro)alkyl” denotes alkyl and fluorosubstituted alkyl.

According to another embodiment, fluorosubstituted alkylene carbonates of formula (X) are applied

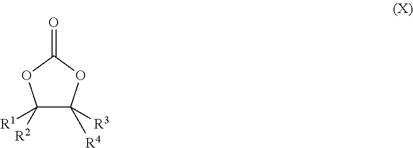

Here, R¹, R², R³ and R⁴ are independently selected from H, linear alkyl groups with 1 to 3 carbon atoms and alkenyl groups with 2 or 3 carbon atom; linear alkyl groups with 1 to 3 carbon atoms or an alkenyle group with 2 or 3 carbon atoms, substituted by at least one fluorine atom; and fluorine, with the proviso that at least one of R¹, R², R³ and R⁴ is fluorine or an alkyl group substituted by at least one fluorine atom.

According to one embodiment, in compounds of formula (X), R¹, R², R³ and R⁴ are selected from H and F, with the proviso that at least one of R¹, R², R³ and R⁴ is fluorine. Especially fluoroethylene carbonate, but also cis- and trans-4,5-difluoroethylene carbonate, 4,4-difluoroethylene carbonate, trifluoroethylene carbonate and tetrafluoroethylene carbonate are very suitable. These compounds can be manufactured by direct fluorination of ethylene carbonate. In the case of difluorosubstituted ethylene carbonate, cis and trans-4,5-difluoroethylene carbonate and 4,4-difluoroethylene carbonate are obtained. These isomers can be separated by fractionated distillation.

According to another preferred embodiment, in compounds of formula (X), R¹is a C1 to C3 alkyl group or a C1 to C3 alkyl group, substituted by at least one fluorine atom; and R², R³ and R⁴ are H or F, with the proviso that at least one of R², R³ and R⁴ are F, or R¹is a C1 to C3 alkyl group, substituted by at least one fluorine atom. Preferably, R¹ is methyl, ethyl or vinyl.

Especially preferred compounds of this type are 4-fluoro-4-methyl-1,3-dioxolane-2-one, 4-fluoro-5-methyl-1,3-dioxolane-2-one, 4-ethyl-4-fluoro-1,3-dioxolane-2one, 5-ethyl-4-fluor-4-ethyl-1,3-dioxolan-2-one and 4,5-dimethyl-4-fluoro-1,3-dioxolane-2-one.

The compounds are known and can be manufactured by fluorination of the respective non-fluorinated compounds or by chlorine-fluorine exchange of the respective chlorosubstituted compounds. 4-Alkyl-4-fluorosubstituted compounds can be manufactured as described in 09161429.7: 4-fluoro-4-R-5-R′-1,3-dioxolane-2-ones are prepared by cyclization of compounds of formula (XI), FC(O)OCHR′C(O)R, wherein R is alkyl and R′ is H or C1 to C3 alkyl. R denotes preferably C1 to C5 alkyl, more preferably, C1 to C3 alkyl. Most preferably, R denotes methyl, ethyl, i-propyl and n-propyl. R′ preferably is H. Especially preferably, R is methyl and R′ is H.

The cyclization reaction is preferably catalyzed by a heterocyclic compound containing nitrogen, or by fluoride ions. In a preferred embodiment, the heterocyclic compound is an aromatic compound. For example, pyridine or 2-methylimidazole can be used as catalyst. Especially preferred are pyridines substituted by at least one dialkylamino group. 4-Dimethylaminopyridine is very suitable. Other 4-dialkylaminopyridines, for example, those wherein alkyl denotes a C1 to C3 alkyl group, are also considered to be suitable.

According to a further preferred embodiment, R¹ and R² are C1 to C3 alkyl groups or C1 to C3 alkyl groups, substituted by at least one fluorine atom; R³ and R⁴ are H or F, with the proviso that at least one of R³ and R⁴ are F, or at least one of R¹ and R² is a C1 to C3 alkyl group, substituted by at least one fluorine atom.

Especially preferred compounds of this type are 4-fluoro-5-(1-fluoroethyl)-1,3-dioxolan-2-one, 4-fluoro-5-(2-fluoroethyl)-1,3-dioxolan-2-one, 4-trifluoromethyl-4-methyl-1,3-dioxolan-2-one, 4-trifluoromethyl-4-methyl-5-fluoro-1,3-dioxolan-2-one and 4-(2,2,2-trifluoroethyl)-4-methyl-5-fluoro-1,3-dioxolan-2-one.

Another group of compounds are trialkyl phosphites wherein at least one alkyl group is substituted by at least one fluorine atom. Tris-(2,2,2-trifluoroethyl)phosphate is the preferred compound. It can be prepared from PCl₃ and trifluoroethanol, optionally in the presence of a base, e.g. an amine.

Still another group of compounds are perfluoroalkyl phosphoranes of formula (XII), (CnF₂ₙ₊ₘ)₅P wherein n is 1, 2, 3, 4, 5, 6, 7 or 8, and m is +1 or −1. They can be prepared from pentaalkyl phosphanes via electrofluorination analogously to the process described in U.S. Pat. No. 6,264,818.

Fluorosubstituted phosphonate esters and phosphate esters of formula (XIII), R—P(O)R¹R², are also suitable. In formula (XIII), R is a C1 to C4 alkyl group; a C1 to C4 alkyl group, substituted by at least 1 fluorine atom; or a fluorosubstituted C2 to C4 alkoxy group; R¹ and R² are the same or different and represent C2 to C4 alkoxy groups, substituted by at least one fluorine atom. Preferred compounds of this type are methyl bis-(2,2,2-trifluoroethyl)phosphonate, ethyl bis-(2,2,2-trifluoroethyl)phosphonate, and tris-(2,2,2-trifluoroethyl)phosphate.

Fluorosubstituted carbonic acid esters of formula (XIV), R—C(O)OR¹ are also suitable. In the formula (XIV), R denotes preferably C1 to C3 and R¹ preferably denotes a C1 to C3 alkyl group with the proviso that at least one of R and R¹ are substituted by at least one fluorine atom. Preferred compounds are 2,2,2-trifluoroethyl butyrate (R═C₃H₇, R¹═C₂H₂F₃), ethyl trifluoroacetate (R═CF₃, R¹═C₂H₅), 2,2,2-trifluoroethyl acetate (R═CH₃, R¹═C₂H₂F₃) and methyl pentafluoropropionate (R═C₂F₅, R¹═CH₃). These compounds are suitable for batteries which are operated at low temperatures as described in US patent application publication 2008/0305401.

Another group of suitable compounds are those of formula (XV), R═C(O)═C(H)═C(H)═OR¹. In compounds of formula (XV), R is a polyfluorinated or perfluorinated alkyl group, and R¹ is C1 to C4 alkyl; C1 to C4 alkyl, substituted by one or more fluorine atoms; or phenyl. R is preferably CF₃, CHF₂, or C₂F₅; and R¹ is preferably methyl or ethyl. The most preferred compound is 4-Ethoxy-1,1,1-trifluoro-3-buten-2-one (ETFBO). These compounds can be prepared by the addition of the respective carboxylic acid chlorides to the respective vinyl ether and subsequent dehydrochlorination. ETFBO, for example, can be prepared from trifluoroacetyl chloride and ethyl vinyl ether. ETFBO is also available e.g. from Solvay Fluor GmbH, Hannover, Germany.

Another group of suitable compounds are polyfluorinated and perfluorinated ethers. Suitable perfluorinated polyethers are described, for example, in WO 02/38718. These perfluorinated polyethers consist essentially of carbon, fluorine and oxygen atoms and comprise at least two, preferably three, C—O—C ether linkages, or a mixture of several compounds satisfying that definition. Often, the oxygen atoms in the perfluoropolyether are exclusively present within the C—O—C ether linkages. The perfluoropolyethers generally have a molecular weight of about 200 or more. Generally they have a molecular weight of less than about 1500. If the polyether is a mixture of several substances, the molecular weight is the weight-average molecular weight. Generally, the perfluoropolyether has a boiling point greater than or equal to 40° C. at 101.3 kPa. The perfluoropolyether generally has a boiling point less or equal to about 200° C. at 101.3 kPa. As a result of the preparation, these perfluoropolyethers often are a mixture of individual substances. Generally, the kinematic viscosity of the perfluoropolyether is less than or equal to 1 cSt (Centistoke) at 25° C. Generally, the kinematic viscosity is at least 0.3 cSt at 25° C.

The preferred perfluoro polyethers are the products marketed by Solvay Solexis under the names GALDEN® and FOMBLIN®.

Examples include:
GALDEN HT 55: boiling point 57° C. at 101.3 kPA; average molecular weight 340
GALDEN HT 70: boiling point 66° C. at 101.3 kPa; average molecular weight 410
FOMBLIN PFS1: boiling point 90° C. at 101.3 kPa; average molecular weight 460

Partially fluorinated polyethers are the hydrofluoro ethers marketed by 3M under the name NOVEC®. The GALDEN® and FOMBLIN® systems are usually multicomponent systems having a boiling point in the range from 40 to 76° C.

Other fluorosubstituted compounds which are suitable as fluorosubstituted compound are lithium fluoro(oxalate)borate and lithium difluoro(oxalato)borate. They are no solvents but an electrolyte salt additive.

Also, fluorinated heterocyclic compounds are suitable as solvent additives, especially, fluorinated dioxolanes, fluorinated oxazolidines, fluorinated imidazolindines, fluorinated dihydroimidazoles, fluorinated 2,3-dihydroimidazoles, fluorinated pyrroles, fluorinated thiophenes, fluorinated thiazoles and fluorinated imidazoles.

Suitable fluorinated dioxolanes are for example 2,2-difluoro-1,3-dioxolane (U.S. Pat. No. 5,750,730) and 2-fluoro-4,4,5,5-tetramethyl-1,3-dioxolane, available from chemstep, France.

Suitable fluorinated oxazolidines are for example 2,2-difluoro-3-methyloxazolidine and 4,5-difluoro-3-methyloxazolidine-2-one, available from chemstep.

Suitable fluorinated imidazolidines are for example 2,2-difluoro-1,3-dimethylimidazolidine, available from abcr, and 1,3-dibutyl-2,2-difluoroimidazolidine available from Apollo.

Suitable fluorinated 2,3-dihydroimidazoles are for example 2,2-difluoro-1,3-dimethyl-2,3-dihydro-1H-imidazole and 1-ethyl-2-fluoro-3-methyl-2,3-dihydro-1H-imidazole, available from chemstep.

Suitable fluorinated imidazoles are for example 1-(trifluoromethyl)-1H-imidazole, available from selectlab, and 2-fluoro-1-(methoxymethyl)-1H-imidazole, available from chemstep.

A suitable fluorinated pyrrole is for example 2-ethyl-5-fluoro-1-methyl-1H-pyrrole, available from chemstep.

A suitable fluorinated thiophene is for example 2-fluorothiophene, available from apacpharma.

A suitable fluorinated thiazole is for example 4-fluorothiazole, available from chemstep. Also, fluorosubstituted organic liquids, e.g. 4,5-dimethyl-3-perfluorooctyl-1,2,4-triazolium tetrafluoroborate.

The fluorinated organic compounds mentioned above can be used as the only solvent, or they are applied in admixture with one or more organic solvents which are not fluorosubstituted.

Preferred mixtures comprise at least one compound selected from the group consisting of monofluoroethylene carbonate, cis-difluoroethylene carbonate, trans-difluoroethylene carbonate, 4,4-difluoroethylene carbonate, 4-fluoro-4-methyl-1,3-dioxolane-2-one, 4-fluoro-4-ethyl-1,3-dioxolane-2-one, 4-trifluoromethyl-1,3-dioxolane-2-one, 2,2,2-trifluoroethyl-methyl carbonate, 2,2,2-trifluoroethyl-fluoromethyl carbonate, and at least one non-fluorinated organic compound selected from the group consisting of ethylene carbonate, propylene carbonate, dimethyl carbonate, diethyl carbonate, and methyl ethyl carbonate.

The electrolyte solvent contains 0.1 to 100% by weight of the fluorosubstituted organic compound, if such a compound or compounds is or are contained. Often, the fluorinated organic compound is contained in the electrolyte solvent in an amount of equal to or more than 1% by weight, preferably equal to or more than 3% by weight. Often, the content is preferably equal to or lower than 20% by weight relative to the electrolyte solvent set as 100% by weight, and more preferably, equal to or lower than 10% by weight.

In battery cells which comprise membranes to separate the metallic lithium from the solvent in the cathode compartment, ionic liquids can be applied in a mixture with any of the fluorosubstituted compounds mentioned above. Very suitable ionic liquids are those based on imidazolium, and pyridinium derivatives, but phosphonium or tetraalkylammonium compounds can also be applied. Representative ionic liquids are tosylate, triflate, hexafluorophosphate, bis-(fluorosulfonyl)amide, bis-(trifluoromethylsulfonyl)amide and tetrafluoroborate of 1-ethyl-3-methylimidazolium, and the octyl sulfate of 1-butyl-3-methylimidazolium.

The Li-air battery cell of the present invention preferably comprises a membrane permeable for lithium ions.

A suitable Li-air battery cell is disclosed in U.S. Pat. No. 5,510,209. The battery cell described therein, for example, in FIG. 1 of U.S. Pat. No. 5,510,209, comprises a lithium foil anode, a polymer electrolyte (comprising polyacrylnitrile, a solvent, e.g. propylene carbonate or ethylene carbonate, and an electrolyte salt, e.g. LiPF₆), a composite positive electrode current collector and an oxygen permeable membrane through which oxygen (from the surrounding air) is transported to the porous carbon electrode.

Another Li-air battery cell is described in JP patent application 2009/032415. The battery cell (which, in fact, is a battery comprising one cell) described therein is said to have a favorable cycle characteristic. The cell described therein comprises: an positive electrode which is an air electrode (also called “air pole”) having an air electrode layer containing a conductive material and an air electrode power collector for collecting electric power from the air electrode layer; a negative electrode having a negative electrode layer containing a negative electrode active material that adsorbs and releases Li ions and a negative electrode power collector for collecting electric power from the negative electrode layer; a separator provided between the air electrode layer and the negative electrode layer; and a fluorosubstituted electrolyte with which at least the separator is impregnated. It also contains a discharge controller that terminates the discharge of the air battery cell. The discharge final voltage of the discharge controller is 2.3 V or higher based on Li metal. The cell also has provisions to handle the volume changes of the electrolyte if the battery charges or discharges. The discharge controller serves to prevent the formation of LiF from LiPF₆ (the commonly applied electrolyte salt) which occurs if the voltage during discharge drops beyond a 2.3V level relative to Li metal.

The negative electrode may be constructed from materials commonly used in Li ion battery cells, e.g. from metallic lithium or carbon. The collector of the negative pole may be made from metals, e.g. copper, stainless steel, or nickel. The air pole may be made from carbon which is preferably porous. The air pole charge collector may be made from metals, e.g. stainless steel, nickel, aluminium, iron, or titanium. It may have the form of a foil, a grid, or a mesh to provide a high surface. The air pole is separated from the ambient atmosphere by a thin porous membrane to filter dust etc. The electrolyte may comprise methyl difluoroacetate, ethyl difluoroacetate, dimethyl difluoromalonate, methyl pentafluoropropionate as fluorosubstituted solvent and fluoroethylene carbonate, fluorobenzene, trifluoromethyl propylene carbonate as fluorosubstituted solvent additive.

The battery cell according to the present invention can be used in a battery comprising a single battery cell or two or more battery cells wherein the electrolyte salt comprises or even consists of LiPO₂F₂; if desired, the solvent of the electrolyte composition may comprise or consist of a non-fluorinated organic electrolyte solvent as described above, a fluorinated organic electrolyte solvent as described above and any mixtures thereof. A polymer gel can be present in the electrolyte, but it is not necessarily present in the battery of the current invention; it is sufficient to provide the lithium ion transporting solvent or solvent mixture which contains or consist of a fluorosubstituted organic compound.

The chemical processes in the Li-air cell include lithium dissolution from the anode surface during discharge, and lithium plating back on to the nominal anode while charging.

During discharge, on the anode, Li is oxidized forming Li⁺. On the cathode, oxygen is reduced to form the O₂²⁻ ion and the O²⁻ ion:

2Li+O₂→Li₂O₂

4Li+O₂→2Li₂O

Upon charging the lithium-air battery cell, the reverse reactions happen. The Li₂O or Li₂O₂, respectively, is broken at the cathode to produce finally elemental oxygen:

2Li₂O→Li₂O₂→O₂.

The Li⁺ ions pass to the anode to be reduced to Li metal.

According to a preferred embodiment, the Li-air battery cell is of the type which contains a membrane between the anode and the cathode compartment; this is mandatory if the anode compartment comprises an organic electrolyte composition while the cathode compartment comprises an aqueous electrolyte composition. Here, the membrane must be permeable for Li ions but not for water or organic liquids. Suitable membranes are described below.

The rechargeability of the Li-air battery cell is improved if the cathode—which often is made from carbon—contains catalysts derived from metal complexes, for example, cobalt phthalocyanine, or oxides of metals such as the oxides of cobalt or mananese. It is assumed that the catalyst lowers the overvoltage for the oxidation of Li₂O₂ or Li₂O to form metallic Li and oxygen.

In the following, preferred electrolyte compositions are listed. The electrolyte salt was always comprised in an amount of approximately 1 mol/liter electrolyte composition The indicated solvent or solvent mixture is the balance to 100% by weight of the respective composition.

TABLE 1
Electrolyte compositions

| | | | Non- | | |
|---|---|---|---|---|---|
| | | | fluorinated | Fluorinated | |
| Compo- | Electrolyte | | solvent | solvent | |
| sition | salt | LiPO₂F₂ | [weight | [% weight, | Additive |
| N° | [% weight] | [% weight] | ratio] | weight ratio] | [% wt] |
| 1 | LiAsF₆ | 1 | EC/PC; 1:1 | F1EC; 5 | — |
| 2 | LiClO₄ | 1 | EC/PC; 1:1 | F1EC; 5 | AND; |
| | | | | | 2.5 |
| 3 | LiN(CF₃SO₂)₂• | 1 | EC/PC; 1:1 | F1EC | — |
| | | | | 2.5/F2EC- | |
| | | | | 2.5; 1:1 | |
| 4 | LiPF₆ | 1 | EC/PC; 1:1 | F1EC; 5 | — |
| 5 | LiPF₆ | 2 | EC/PC; 1:1 | — | — |
| 6 | LiPF₆ | 2 | EC/PC; 1:1 | — | |
| 7 | LiPF₆ | 2 | EC/PC; 1:1 | — | PN; 2 |
| 8 | LiPF₆ | 2 | EC/PC; 1:1 | — | SN; 2 |
| 9 | LiPF₆ | 2 | EC/DEC; | F1EC; 5 | GN; 2 |
| | | | 1:1.25 | | |
| 10 | LiPF₆ | 2 | EC/DEC; | F1DMC; 5 | — |
| | | | 1:1.25 | | |
| 11 | LiPF₆ | 5 | EC/DEC; | 4-FPC; 5 | — |
| | | | 1:1.25 | | |
| 12 | LiPF₆ | 5 | EC:PC; 1:1 | FMTFEC; 3 | — |
| 13 | LiPF₆ | 8 | EC/DEC; | F3EC; 3 | PNG; 2 |
| | | | 1:1.25 | | |
| 14 | LiPF₆ | 8 | EC:TG; 1:1 | F1EC; 5 | — |
| 15 | LiPF₆ | 8 | EC/DEC; | F4EC; 5 | — |
| | | | 1:1.25 | | |

Abbreviations:
DEC = diethyl carbonate
EC = ethylene carbonate
PC = propylene carbonate
TG = tetraglyme
F1EC = monofluoroethylene carbonate
F2EC = difluoroethylene carbonate (mixture containing cis-4,5, trans-4,5 and 4,4-isomers)
F3EC = trifluoroethylene carbonate
F4EC = tetrafluoroethylene carbonate
F1DMC = fluoromethyl methyl carbonate
4FPC = 4-fluoro-4-methyl-1,3-dioxolane-2-one
FMTFEC = fluoromethyl 2,2,2-trifluoroethyl carbonate
ADN = adiponitrile
SN = succinonitrle
GN = glutaronitrile
PN = propionitrile

The electrolyte compositions can be applied in batteries with liquid electrolytes and in battery cells with gel state electrolytes. In gel state electrolytes, the non-aqueous solvents are gelled through the use of a gelling agent such as polyacrylonitrile, polyethylene oxide, polyvinylidene fluoride. Polymerizable monomers that are added to the non-aqueous solvent system and polymerized in situ by the use of heat or radiation may also be used.

As mentioned above, a preferred battery cell of the present invention comprises a membrane between the anode and cathode compartments. Highly suitable membranes are described in U.S. Pat. No. 7,390,591 which is incorporated herein by reference in its entirety for all purposes. These membranes, are highly conductive for ions of the active metal, but are otherwise substantially impervious. They are chemically stable and protect the active metal anode from deleterious reactions with other battery components and decouple the chemical environments of the anode and the cathode. They may be monolithic or be composed of two or more layers.

A first layer, for example, which is in contact with the active metal, may be partially or completely composed of Li₃N, Li₃P, LiI, LiBr, LiCl, LiF and LiPON.

A second layer may be composed of material that is substantially impervious, ionically conductive and chemically compatible with the first material (or its precursor). Suitable materials include glassy or amorphous metal ion conductors, for example, phosphorus-based or oxide based glasses, phosphorus-oxynitride-based glass, selenide-based glass, gallium-based glass, germanium-based glass and boracite glass. Ceramic active metal ion conductors, such as lithium beta-alumina, sodium beta-alumina, Li superionic conductor (LISICON), Na superionic conductor (NASICON) and the like, and glass-ceramic active metal ion conductors are also suitable. Specific examples, e.g. LiPON, are found in U.S. Pat. No. 7,390,591 in column 4, lines 1 to 39.

The layers may further comprise additional components, e.g. polymers, for example, polymer-iodine complexes like polyethylene-iodine, or polymer electrolytes to form flexible composite sheets of material which may be used as second layer of the protective composite. For example, a composite of a Li-ion conducting glass-ceramic material and a solid polymer electrolyte based on polyethyleneoxide-Li salt complexes. Such a material is available from the company Ohara Corp.

The cathode is preferably one of those described in column 15 of U.S. Pat. No. 7,390,591. Suitable cathodes include LiₓCoO₂, LiₓNiO₂, LiₓMn₂O₄, LiFePO₄, AgₓV₂O₅, CuₓV₂O₅, V₂O₅, V₆O₁₃, FeS₂ and TiS₂.

The manufacture of the battery cells is known in the art as indicated in U.S. Pat. No. 7,390,591 in column 15, line 33 to column 16, line 2.

The advantage of the battery cells and consequently of batteries composed of a multitude of cells of the present invention is a high energy density per volume.

LiPO₂F₂ can be manufactured from Li₃PO₄ and POF₃ as described in unpublished patent application EP 10188108.4 filed in the name of Solvay SA on Oct. 19, 2010 corresponding to WO 2012016924. LiPO₂F₂ is manufactured in a gas-solid type reaction preferably at a temperature in the range of 0° C. to 100° C. and a pressure preferably higher than 5 bar (abs) by the reaction of phosphoryl fluoride (POF₃) and lithium orthophosphate (Li₃PO₄) according to the equation

2POF₃+Li₃PO₄→3LiPO₂F₂

Since no byproduct is ideally produced from the reaction, the purity of LiPO₂F₂ is very high.

EP-A-2 065 339 discloses how to manufacture a mixture of LiPF₆ and LiPO₂F₂ from a halide other than a fluoride, LiPF₆ and water. The resulting salt mixture, dissolved in aprotic solvents, is used as an electrolyte solution for lithium ion batteries. EP-A-2 061 115 describes the manufacture of LiPO₂F₂ from P₂O₃F₄ and Li compounds, and the manufacture of LiPO₂F₂ from LiPF₆ and compounds with a Si—O—Si bond, e.g. siloxanes. US-A 2008/305402 discloses preparation of LiPO₂F₂ from LiPF₆ with a carbonate compound.

A further aspect of the invention concerns a vehicle battery, especially preferably a car battery, constituted of a multitude of lithium-air battery cells of the present invention. The term “vehicle” includes cars, motor cycles, planes, trains, lorries and electrically driven bicycles.

The battery of the invention is not only suitable as a battery in a vehicle with an internal combustion engine, but also in vehicles with hybrid drive, i.e. vehicles which may be driven by electric power and internal combustion engine, but also in vehicles which are driven only by electric power supplied from the battery.

Should the disclosure of any patents, patent applications, and publications which are incorporated herein by reference conflict with the description of the present application to the extent that it may render a term unclear, the present description shall take precedence.

The following examples are intended to explain the invention without limiting it.

### EXAMPLE

A coin cell type lithium-air battery is provided which corresponds to the battery type of FIGS. 1a and 1b of JP-A 2009/032415. It comprises a negative pole which may be made from metal, e.g. copper, stainless steel or nickel and may be present, for example, in the form of a foil, a mesh or a grid, a positive pole (“air pole”) which may be made, for example, from a porous carbon material supporting the catalyst mentioned above, e.g. manganese oxide, and respective current collectors. The anode contains a layer of lithium. The cathode is in contact with the surrounding air; to protect it against dust, an air-permeable membrane separates the air pole from the ambient space. The battery further contains as a separator a substantially non-porous lithium-ion conductive membrane between the anode compartment and the cathode compartment. It may be, for example, a porous membrane made from polyethylene or polypropylene. The membrane may also be for example a LISICON membrane as available from Ceramatec Inc., Salt Lake City, USA, e.g. a membrane based on Li₁₊ₓAlₓTi₂₋ₓ(PO₄)₃ wherein x is between 0.0 and 0.5. If desired, the membrane can be infused with a lithium salt, e.g. LiPF₆, to conduct lithium ions between anode and the membrane.

The electrolyte composition is in contact with both the anode and the cathode is selected from one of the mixtures compiled in table 1; for example, composition N° 9 is very suitable.

### Operation of the Battery:

If the battery cell described above is discharged, lithium metal is oxidized at the anode to produce lithium ions. The electrons pass through a power consuming equipment, and the lithium ions are conducted through the membrane to the cathode where they react with oxygen from surrounding air gradually forming Li₂O₂ and Li₂O. The voltage may drop from approximately 3 V a lower value; it is preferred to stop the discharge before 2.3 V are reached.

When the battery cell is connected to a power source, it will be recharged. Here, the lithium ions from the cathode compartment migrate through the membrane to the anode compartment and are combined with electrons to form elemental lithium. In the cathode compartment, elemental oxygen forms from the O⁻ and O²⁻ ions, respectively (depending on the status of discharge).

### EXAMPLE 2

### Li-Air Type Car Battery

The car battery comprises 20 cells which are assembled in line thus providing a voltage which is the sum of the respective voltage of the cells. A shut-off installation shuts the current off if the voltage is lower than 46 V during discharge. Each cell is arranged in a cell housing. The cell housing comprises an anode made of Li metal which is in contact with an electrolyte solution comprising 1 mol/liter of LiPF₆, 2% by weight of LiPO₂F₂, 3% by weight of monofluoroethylene carbonate (“F1EC”) and as balance to 100% by weight of the total electrolyte composition, a mixture of ethylene carbonate and propylene carbonate in a weight ratio of 1:1. The same electrolyte composition is in the cathode compartment. The anode compartment and the anode compartment are separated by a Lisicon membrane which comprises LiPF₆ as electrolyte salt. The air electrode made from Ni is in contact with the electrolyte solvent in the cathode compartment. An electric consumer (e.g., an electric motor driving the vehicle, or a conventional consumer of electric current, for example, the car radio) is arranged between the plus pole which is formed from a carbon electrode being in contact with the Li metal, and the Ni made minus pole. If the electric consumer is operating, electric current flows from the minus pole to the plus pole. For charging, voltage is applied (e.g. from the generator of the motor or a battery charger), and electric current flows from the plus pole to the minus pole thus charging the battery again.

In another alternative, the car battery as described in this example comprises an electrolyte based on water in the cathode compartment.

1. A lithium-air battery cell comprising an electrolyte composition which comprises LiPO₂F₂.

2. The lithium-air battery cell of claim 1 wherein the content of LiPO₂F₂ is 1 to 10% by weight.

3. The lithium-air battery cell of claim 1 wherein the electrolyte composition comprises at least one electrolyte solvent selected from the group consisting of non-fluorinated aprotic organic compounds and fluorinated aprotic organic compounds.

4. The lithium-air battery cell of claim 1 wherein the electrolyte composition comprises an electrolyte solvent which comprises of at least one fluorosubstituted organic compound which contains at least one heteroatom selected from the group consisting of oxygen, nitrogen, phosphorous, sulfur and silicon.

5. The lithium-air battery cell of claim 4 wherein the fluorosubstituted electrolyte solvent is selected from the group consisting of fluorosubstituted carboxylic acid esters, fluorosubstituted carboxylic acid amides, fluorosubstituted fluorinated ethers, fluorosubstituted carbamates, fluorosubstituted cyclic carbonates, fluorosubstituted acyclic carbonates, fluorosubstituted ethers, perfluoroalkyl phosphoranes, fluorosubstituted phosphites, fluorosubstituted phosphates, fluorosubstituted phosphonates and fluorosubstituted heterocycles.

6. The lithium-air battery cell of claim 5 wherein the fluorosubstituted electrolyte solvent is selected from the group consisting of monofluoroethylene carbonate, cis-difluoroethylene carbonate, trans-difluoroethylene carbonate, 4,4-difluoroethylene carbonate, trifluoroethylene carbonate, tetrafluoroethylene carbonate, 4-fluoro-4-methyl-1,3-dioxolane-2-one, 4-fluoro-4-ethyl-1,3-dioxolane-2-one, 2,2,2-trifluoroethyl-methyl carbonate, and 2,2,2-trifluoroethyl-fluoromethyl carbonate.

7. The lithium-air battery cell of claim 3 wherein the non-fluorinated electrolyte solvent is selected from the group consisting of alkyl carbonates, alkylene carbonates, and ethers.

8. The lithium-air battery cell of claim 7 wherein the non-fluorinated electrolyte solvent is at least one solvent selected from the group consisting of 1,2-dimethoxyethane, tetraglyme, tetrahydrofuran, 2-methyltetrahydrofuran, 1,3-dioxolane, 4-methyldioxolane, dimethylcarbonate, ethylmethyl carbonate, diethyl carbonate and any mixtures thereof.

9. The lithium-air battery cell of claim 1 which further comprises a membrane which is selectively conductive for lithium ions.

10. The lithium-air battery cell of claim 1 wherein the electrolyte composition further comprises LiPF₆ as electrolyte salt.

11. The lithium-air battery cell of claim 10 wherein the concentration of LiPF₆ in the electrolyte composition is 1±0.1 molar.

12. The lithium-air battery cell of claim 1 wherein the electrolyte composition further comprises a mononitrile with a C1 to C20 alkyl chain or a dinitrile with a C1 to C20 alkylene chain.

13. The lithium-air battery cell of claim 1 wherein the electrolyte composition of the anode compartment and the electrolyte composition of the cathode compartment are identical.

14. The lithium-air battery cell of claim 1 wherein the electrolyte composition of the anode compartment is based on an aprotic organic solvent, and the electrolyte composition in the cathode compartment is based on water as solvent.

15. A battery constituted of a multitude of lithium-air battery cells according to claim 1.

16. The lithium-air battery cell of claim 1 wherein the electrolyte composition comprises an electrolyte solvent which consists of at least one fluorosubstituted organic compound which contains at least one heteroatom selected from the group consisting of oxygen, nitrogen, phosphorous, sulfur and silicon.
